(19) United States
(12) Patent Application Publication
(10) Pub. No.: US 2012/0267475 A1
(43) Pub. Date: Oct. 25, 2012

(54) ACOUSTIC SEAL FOR AIRCRAFT

(76) Inventor: FERNANDO CAMPOS, Van Nuys, CA (US)

(21) Appl. No.: 13/090,597

(22) Filed: Apr. 20, 2011

(51) Int. Cl. B64C 1/40; E06B 7/16; E06B 7/22; B64C 1/14

(52) U.S. Cl. 244/1 N; 49/489.1

(57) ABSTRACT

An acoustic seal device is placed around the periphery of aircraft doors for reducing reducing wind noises transmitted into the aircraft cabin by the door gaps without adding additional weight to the aircraft. The acoustic seal includes a pre-shaped body made of a soundproofing material. The pre-shaped body is adapted to be secured to a door opening and has a shape that matches the shape of the door opening.

### BACKGROUND OF THE INVENTION

The present invention generally relates to acoustic sealing devices, and more particularly to an aircraft acoustic sealing device for aircraft doors and/or openings.

Aircraft doors and baggage doors are designed to include a gap around the perimeter of the door and/or opening to prevent mechanical interference with the fuselage. To keep the pressurization of the aircraft cabin, pressure sealing devices are used to fill this gap. As an aircraft travels forward through the air, wind noise is generated by the gaps around the doors. The noise is transmitted into the cabin area providing discomfort to the passengers and/or crew. Currently, some aircraft manufacturers have attempted to address this problem by installing a curtain or secondary door just inboard of the door. Unfortunately, these methods fail to effectively suppress the noise and also adds additional weight to the aircraft.

As can be seen, there is a need for a noise suppression device that prevents the wind noise from reaching the aircraft cabin without adding too much weight to the aircraft.

### SUMMARY OF THE INVENTION

In one aspect of the present invention, an acoustic seal has a pre-shaped body made of a soundproofing material, the pre-shaped body is adapted to be secured to an aircraft door opening, and the pre-shaped body has a shape that matches the shape of the aircraft door opening.

In another aspect of the present invention, an acoustic seal has a pre-shaped body made of a soundproofing material, a cover attached to the pre-shaped body, the pre-shaped body is adapted to be secured to a door opening, and the pre-shaped body has a shape that matches the shape of the door opening.

These and other features, aspects and advantages of the present invention will become better understood with reference to the following drawings, description and claims.

### BRIEF DESCRIPTION OF THE DRAWINGS

FIG. 1 illustrates a cross-sectional view of an aircraft cabin showing an acoustic seal device according to an exemplary embodiment of the present invention;

FIG. 2 illustrates a right side, top view looking down, of the aircraft cabin door arrangement of FIG. 1;

FIG. 3 illustrates a detailed view of the acoustic seal shown along line 3-3 of FIG. 2; and

FIG. 4 illustrates a cross-sectional view of an acoustic seal according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide an acoustic seal device to be placed around the periphery of aircraft doors for effectively reducing wind noises transmitted into the aircraft cabin by the door gaps.

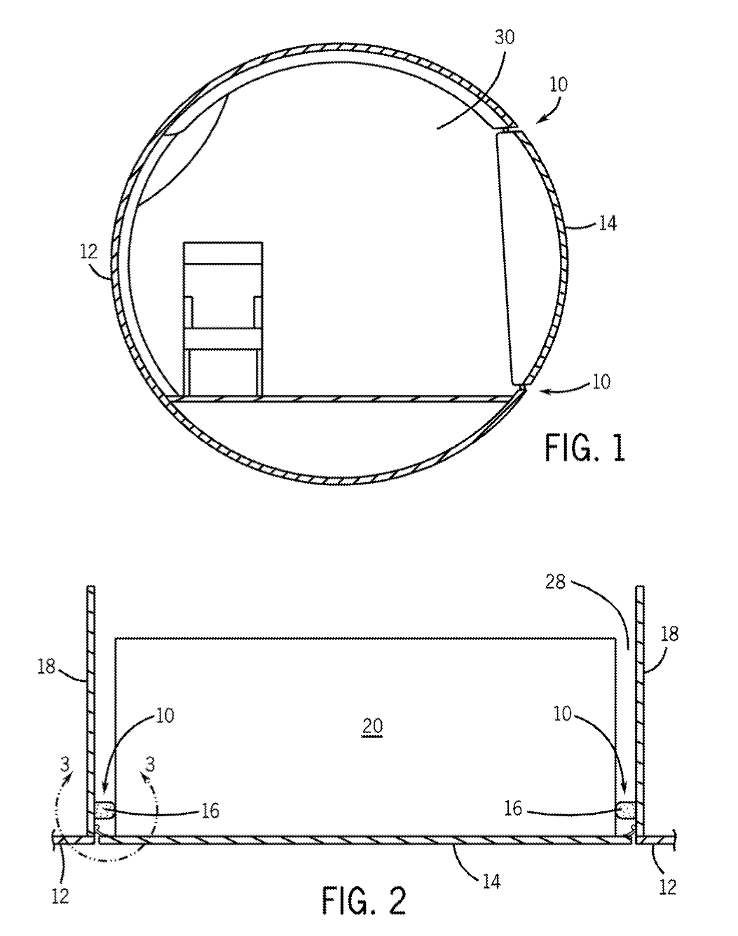

FIG. 1 illustrates an aircraft cabin 30 showing an acoustic seal device 10 according to an exemplary embodiment of the present invention. The acoustic seal device 10 may be placed between an aircraft door 14 and an aircraft fuselage 12. The aircraft doors 14 may be main entry doors, auxiliary cabin doors, emergency exit doors, baggage doors, or any panel or openings used on aircrafts.

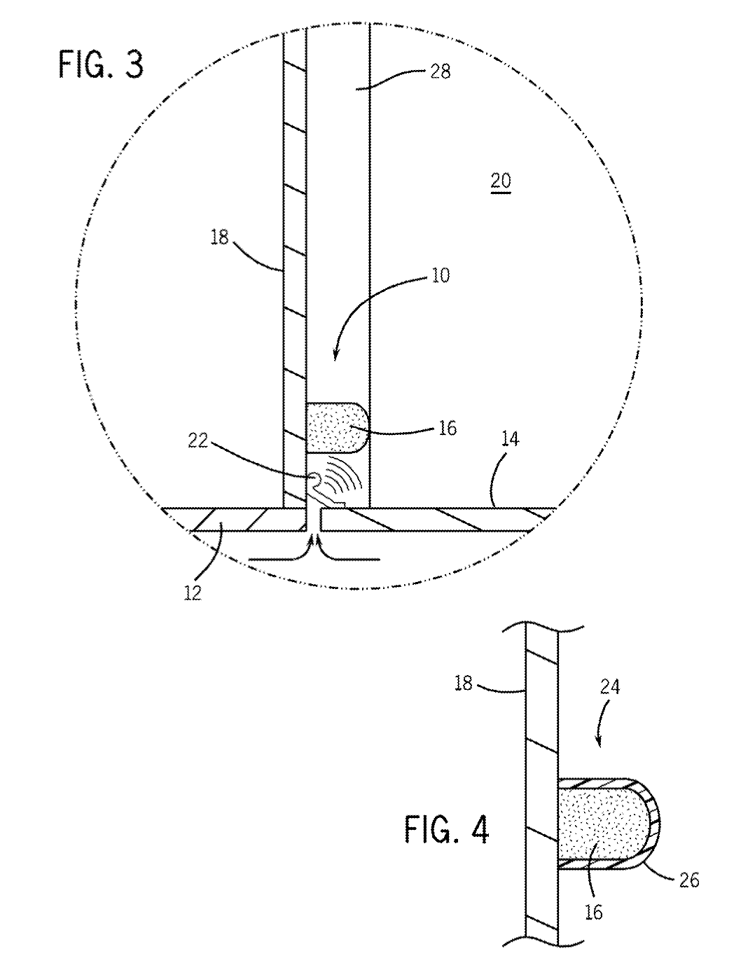

FIGS. 2-3 illustrate a gap 28 or an area of noise reduction located between the aircraft door 14 and the aircraft bulkhead 18, which may be caused by the effective use and application from the acoustic seal device 10. The acoustic seal device 10 reduces the wind noise that is transmitted into the cabin 30. A pressure seal 22 is typically used to fill the gap 28 to keep the aircraft cabin 30 pressurized. The acoustic seal device 10 may be secured to the aircraft fuselage 12, aircraft doors 14, floor (not shown), headliners (not shown), and/or a bulkhead panel 18 (hereafter collectively called aircraft doors 14). The acoustic seal device 10 may be secured around the aircraft doors 14 by using adhesives, double-sided tape, hook and loop fasteners, nails, resins, stitches, epoxy, screws, bolts, glue, welding, or heat. The acoustic seal device 10 may be placed as close as possible to the pressure seal 22 to provide the best noise suppression. The acoustic seal device 10 may be designed to be removable and installed on in “as needed” basis.

The acoustic seal device 10 may include a pre-shaped body 16 made of a soundproofing material. The soundproofing material may meet the Federal Aviation Administration (FAA) flammability requirements. In some embodiments, the pre-shaped body 16 may be made of foam, rubber, silicone, neoprene, air bubbles, plastic, or any other commercially available soundproofing material. The pre-shaped body 16 may have a shape and size that match the variety of commercially available aircraft doors 14. In some embodiments, the pre-shaped body 16 may be approximately 2 inches wide and 1.5 inches high. The pre-shaped body 16 may include a chamfer on the side that makes contact with the aircraft fuselage 12, aircraft doors 14, floor (not shown), headliners (not shown), and/or a bulkhead panel 18.

In some embodiments, the pre-shaped body 16 may include a flat face to be attached to the aircraft fuselage 12, aircraft doors 14, floor (not shown), headliners (not shown), and/or a bulkhead panel 18.

The acoustic seal device 10 may not interfere with the aircraft pressurization system and/or pressure seal 22.

FIG. 4 illustrates another exemplary embodiment of an acoustic seal device 24 according to the present invention. A cover 26 may be placed around the pre-shaped body 16 to provide an aesthetic appearance to the acoustic seal device 10. In some embodiments, the cover 26 may be made of leather, ultra-leather, vinyl, plastic, polymer, fabric, or composite material. The shape of the cover 26 may match the shape of the pre-shaped body 16.

The acoustic seal device 10 may suppress the wind noise entering the cabin 30, resulting in a more comfortable area for passengers and/or crew. In addition, the acoustic seal device 10 may suppress the wind noise entering the cabin 30 without adding additional unwanted weight of the traditional aircraft soundproofing. The decrease in weight represents an improved aircraft performance, including operational and cost advantages. In addition, the weight decrease may allow the aircraft operators to fly the aircraft at a lower weight which allows enhanced takeoff performance resulting in safer risk margins.

The acoustic seal device 10 may also be used in automobiles, trains, boats, buildings, high rises, housing structures, homes, or any door arrangement that is susceptible to noise.

It should be understood, of course, that the foregoing relates to exemplary embodiments of the invention and that modifications may be made without departing from the spirit and scope of the invention as set forth in the following claims.

What is claimed is:

1. An acoustic seal comprising:
a pre-shaped body made of a soundproofing material;
wherein the pre-shaped body is adapted to be secured to an aircraft door opening; and
wherein the pre-shaped body has a shape that matches a shape of the aircraft door opening.

2. The acoustic seal according to claim 1, wherein the acoustic seal is secured to the door opening by using adhesives, double-sided tape, hook and loop fasteners, nails, resins, stitches, epoxy, screws, bolts, glue, welding, or heat.

3. The acoustic seal according to claim 1, wherein the pre-shaped body is made of foam, rubber, silicone, neoprene, air bubbles, or plastic.

4. The acoustic seal according to claim 1, wherein the pre-shaped body includes a flat face that is secured to the door opening.

5. An acoustic seal comprising:
a pre-shaped body made of a soundproofing material;
a cover attached to the pre-shaped body;
wherein the pre-shaped body is adapted to be secured to a door opening; and
wherein the pre-shaped body has a shape that matches a shape of the door opening.

6. The acoustic seal according to claim 5, wherein the cover is made of leather, ultra-leather, vinyl, plastic, polymer, fabric, or composite material.

7. The acoustic seal according to claim 5, wherein the cover has a shape that matches the shape of the pre-shaped body.

8. The acoustic seal according to claim 5, wherein the pre-shaped body is made of foam, rubber, silicone, neoprene, air bubbles, or plastic.

9. The acoustic seal according to claim 5, wherein the acoustic seal is removable from the aircraft door opening.
